(19) United States
(12) Patent Application Publication
(10) Pub. No.: US 2018/0162584 A1
(43) Pub. Date: Jun. 14, 2018

(54) X-RAY DETECTABLE SECURITY BIN HAVING HANDLES

(71) Applicant: Jeffrey Tauber, Hillsborough, NJ (US)

(72) Inventor: Jeffrey Tauber, Hillsborough, NJ (US)

(21) Appl. No.: 15/836,738

(22) Filed: Dec. 8, 2017

Related U.S. Application Data
(60) Provisional application No. 62/431,805, filed on Dec. 8, 2016.

(51) Int. Cl. B65D 1/34; B62B 3/14; G01N 23/04; G01V 5/00

(52) U.S. Cl. CPC B65D 1/34; B62B 3/146; B62B 5/061; G01V 5/0033; G01N 23/04

(57) ABSTRACT

A security bin for use in separating and X-ray scanning personal belongings as part of a security screening process, wherein the bin comprises cantilevered handles comprising at least one bin identification number that is detectable by X-ray. The handles extend outwardly from a perimeter side or edge of the bin, wherein the perimeter defines an opening of the bin. The security bin further comprises an identification number that is optically detectable and corresponds to the identification number that is detectable by X-ray.

### RELATED APPLICATIONS

This application claims priority from Provisional Application Ser. No. 62/431,805, filed on Dec. 8, 2016, which is hereby incorporated by reference in its entirety.

### FIELD OF THE INVENTION

The present disclosure relates generally to a bin or tray for use with X-ray screening and inspection devices, particularly a bin or tray having one or more cantilevered handles positioned outside of a plane of one or more of the sidewalls of the bin, wherein the bin or tray is configured to hold and segregate an assortment of articles to be screened by an X-ray device.

### BACKGROUND OF THE INVENTION

Recently, due to the need for increased security in many venues of public accommodation and modes of public transportation, most particularly in airports, to ensure passenger safety it has become necessary and desirable to screen all patrons, passengers and their belongings before permitting admittance into secure areas within facilities such as airport terminals, train stations, military, law enforcement and court facilities, prisons, bus depots or sports venues. A quick and effective way to screen patron and passenger belongings for the presence of hidden contraband is with an X-ray device which allows security personnel to quickly and carefully screen a large number of items without undue delay or inconvenience.

In order to segregate passenger/patron belongings by individual owner, plastic bins are presently used by TSA in the security areas in airports within the United States for the purpose of taking passenger carry-on belongings through X-ray screening machines to ensure they do not contain items that could possibly jeopardize the safety of the airplanes and their passengers. Although currently available plastic bins are successful in holding and separating personal belongings of fellow travelers, current methods for X-ray and manual inspection of these inefficient and error prone, which creates substantial security risk.

For example, plastic bins are generally passed through an X-ray machine located on a passenger screening line, wherein the bins are visible only to the TSA X-ray operator as X-ray images, as the bins move through the X-ray screening machine. The X-ray images lack clarity and realistic coloring, such that the X-ray images do not accurately reflect the real-world appearance of the personal items in the plastic bin. Thus, attempts to identify a plastic bin by visual observation of the plastic bin's contents often results in difficulties, delay and confusion in positively identifying and describing a bin. The difficulties further extend to confusion and inefficiency when attempting to instruct a co-worker to correctly identify and remove a suspect plastic bin for manual examination, thereby causing delays in completing the screening process and introducing false positive and negative bin identifications which compromise security and reduce the effectiveness of the screening process. Additionally, prior art bins used for X-ray screening are bins that are typically not designed and constructed for use in an X-ray screening process and particularly for use in a high-volume X-ray screening system and therefor lack certain features and structures to facilitate the efficient and accurate screening of patron items and articles.

Plastic bins are presently used by the TSA in the security areas in airports within the USA for the purpose of taking passenger carry-on belongings through X-ray screening machines to ensure they do not contain items that could possibly jeopardize the safety of the airplanes and their passengers. These plastic bins are generally uniform in size and appearance, wherein the plastic bins are indistinguishable from one another. However, in some instances plastic bins have been modified to include an identification number that is visibly displayed on one or more sides of the plastic bins. These identifying numbers are useful in assisting passengers to track their plastic bin after it leaves the X-ray screening machine. These identifying numbers may also be useful to assist TSA officers in communicating with passengers about a specific plastic bin. However, these identifying numbers are not visible to the X-ray operator while the plastic bin is in the X-ray screening machine.

The standard protocol for examining the contents of the plastic bins requires an X-ray operator to review images of each plastic bin on a display screen of the X-ray screening machine. When an X-ray machine operator identifies a potential risk in one of the X-ray images, the operator requests other assisting TSA officers to collect and remove the suspect plastic bin from the remaining bins for further inspection. Due to the identical appearance of the plastic bins, the X-Ray machine operator and other assisting TSA officers are required to spend additional time communicating and examining the plastic bins to ensure the suspect plastic bin is correctly selected. Once the correct plastic bin has been identified and confirmed with the X-ray operator, the TSA officer removes the suspect plastic bin from the X-ray screening machine for storage until-another TSA officer retrieves the suspect plastic bin for manual examination. Since the X-ray machine operator is the only person that has seen and can identify the suspect plastic bin, all other TSA officers are required to rely on the X-ray machine operator's memory, counting accuracy, verbal clues, and verbal directions to find, remove and examine the suspect plastic bin. Thus, the only time the other TSA officers see the suspect plastic bin is after the X-ray machine operator confirms the identity of the plastic bin, and after the identity of the owner of the bin's contents has been identified. Accordingly, the TSA experiences an inordinate amount of false bin identifications, as there is no sure way of selecting the suspect bin without the direct help of the X-ray machine operator. When the wrong plastic bin is pulled off the line, this will often lead to confusion, which slows the screening process and may even result in a temporary shutdown of the entire bin screening process. Aside from the inconvenience, current screening methods and equipment add uncertainty and insecurity to the entire security process.

Some plastic security bins have been modified to include identifying information that is detectable by X-ray. This is accomplished by placing X-ray detectable alphanumeric characters on various surfaces of existing plastic security bins. The geometries, shapes, dimensions and other surfaces of existing security bins limits the placement of identifying information that may be viewable by an X-ray machine operator, or that may be clearly observed when personal items are placed in the bin. For example, in some bins identifying information has been placed on the rim or lip edge of the bin opening. For these bins, the limited width of the rim or lip edge requires that the identifying information be provided in a sufficiently small font size, which may create difficulty in quickly and accurately assessing the information. Further, as multiple bins pass through the X-ray machine, the lip edges of adjacent bins will often overlap, thereby obstructing the identifying information of one or more of the bins. Identifying information placed on or within the sidewalls of the bin is positioned in a parallel plane to the overhead view of the X-ray machine, and therefore cannot be seen by the X-ray operator. Further, identifying information that is placed inside the body of the bin may be obstructed by personal items placed on top of the identifying information.

Thus, although methods and equipment for screening personal items of individuals are available, challenges still exist. The present invention addresses these challenges.

### SUMMARY OF THE INVENTION

In one aspect of the present invention, a security bin is provided having a body comprising a bottom surface in a first plane and four sidewalls extending upwardly from the bottom surface and in a second plane that is perpendicular to the first plane, said bottom surface and sidewalls defining a cargo compartment for receiving personal items. Said body further comprises an opening positioned opposite the bottom surface, and defined by an edge that extends about an upper perimeter of the four sidewalls. The body further comprises at least one handle that is positioned external to the opening and in a plane that is parallel to the bottom surface, wherein the handle extends outwardly from the body in a cantilevered fashion. In some instances, the at least one handle comprises two handles positioned on opposite sides of the body. In some instances, the handle comprises a base that is coupled to the edge. In some instances, the handle comprises a base that is coupled to an outer surface of one or more of the sidewalls. In some instances, the handle comprises a base having a first portion that is coupled to the edge and a second portion that is coupled an outer surface of a sidewall. In some instances, the handle further comprises a grip portion that is separated from the edge and/or sidewall surface by a gap configured to accommodate a user's fingers while gripping the grip portion.

In one aspect, the handle comprises one or more compartments configured to receive a bin identification number that is detectable by X-ray. In some instances, the one or more compartments are hidden within an interior surface or structure of the handle. In some instances, a grip portion of the handle is removable, wherein the one or more compartments are accessible when the grip portion of the handle is removed. In some instances, the handle comprises three compartments. In some instances, the handle further comprises one or more receptacles for selectively receiving and retaining the grip portion onto the base of the handle. In some instances, the handle comprises five compartments in a linear arrangement, wherein the three inner compartments are configured to receive three individual alphanumeric bin identification characters, and the two outer compartments are configured to receive attachment clips of the grip portion to retain the grip portion onto the base of the handle. In some instances, the plurality of compartments further provides structural rigidity to the handle and/or grip portion of the handle.

In another aspect, the present invention provides a security bin having one or more cantilevered handles positioned external to an opening of the bin and positioned in a plane perpendicular to the sidewalls of the bin, wherein the cantilevered handles extend an overall length of the bin to provide and maintain a desired spacing between adjacent bins while being processed through an X-ray scanning machine. In some instances, the cantilevered handles further comprise a bin identification number or other alphanumeric identifying information that is located external to the opening of the bin, and external to one or more sidewall planes of the bin.

In another aspect, the present invention provides a security bin having one or more cantilevered ergonomic handles positioned external to an opening of the bin and positioned in a plane perpendicular to the sidewalls of the bin, wherein the cantilevered ergonomic handle provides a prominent gripping surface that improves a user's ability to grip and hold the security bin, and reduces wrist strain that may occur when attempting to lift a security bin by grasping a narrow lip edge surface with the user's fingertips.

In another aspect, a security bin is provided which allows the user and other observers to immediately identify the security bin by means of visually observing an identification number on one or more surfaces of the bin, wherein the identification number is observable as it enters and exits the X-ray machine, thus minimizing loss or theft of personal belongings, as well as improving the speed, efficiency and confidence in the security process. The identification number is also observable by the X-ray machine operator while the security bin is located within the X-ray scanning machine, thereby enabling the X-ray operator to communicate the identity of the plastic bin to a co-worker by sole reference to the identification number. In turn, the co-worker (i.e., another TSA officer) is able to identify the owner of the contents of the security bin by mere reference to the identification number in questioning the patrons.

Another aspect of the invention provides a security bin having an identification number that is visible both to the naked eye and radiopaque, wherein the identification number is detectable by X-rays. In some instances, the security bin comprises two or more identical identification numbers, wherein the first identification number is positioned so as to be visible only to the naked eye, and the second identification number is positioned so as to be visible to an X-ray operator as the bin passes through an X-ray scanning machine. In some instances, the identification number detectable by X-ray is not optically detectable.

Another aspect of the invention provides a method for tracking a plastic bin through an X-ray scanning machine, wherein the method provides steps for i) providing a security bin having at least one identification number coupled to or comprising at least one surface of the security bin, wherein the identification number comprises a radiopaque material and is positioned so as to be optically visible and visible to an X-ray operator as the security bin passes through an X-ray scanning device; ii) noting the identification number prior to passing the security bin through an X-ray scanning machine; iii) recognizing the identification number of the security bin while the bin is located within the X-ray scanning machine; and iv) directing an individual to select the security bin by communicating the recognized identification number to person once the bin has exited the X-ray scanning machine.

A further aspect of the present invention provides a method of manufacturing a security screening bin, comprising steps for: manufacturing a bin by plastic injection molding including molding a cantilevered handle extending from at least one of the edge and a sidewall, such that the handles are positioned outside of, or external to the opening of the bin and a plane of the sidewall.

According to another aspect of the present invention, a method of performing X-ray security screening using a security bin according to the present invention includes: providing a security bin for the use of patrons seeking access to a secured area, and requiring patrons to place personal items in the security bin.

According to another aspect of the present invention, a security bin comprises: an open top, a generally planar floor, a pair of lateral sidewalls and a pair of longitudinal sidewalls, wherein each of said pair of lateral sidewalls and said longitudinal sidewalls are arranged and attached along the perimeter of said generally planar floor in an orthogonal orientation, and wherein each of said lateral sidewalls are attached to each of said longitudinal sidewalls at a substantially right angle, and wherein an edge of said lateral and longitudinal sidewalls positioned opposite of said generally planar floor comprises a lip edge or edge surface of the security bin, wherein the lip edge or edge surface defines an opening of the security, said security bin further comprising a pair of cantilevered handles coupled to at least one of: i) two oppositely positioned sidewalls, and ii) the lip edge or edge surface, wherein grip portions of the pair of cantilevered handles are positioned external to the lip edge or edge surface, the sidewalls, and the generally planar floor.

sidewall According to another aspect of the present invention, the bin identification number comprises a radiopaque material selected from the group consisting of a metal plate, a metal sheet, a polymer, an ink, a dye, or any combination thereof, said bin identification number further being embedded in each of the handles.

According to another aspect of the present invention, a security bin further includes a bin number that is optically detectable and affixed to the outside surface of each lateral and each longitudinal sidewall. In some instances, the optically detectable bin number corresponds to the X-ray readable bin number. In some instances, the optically detectable bin number is molded into an exterior surface of the sidewalls of the bin. In some instances, the optically detectable bin number mechanically fixed onto an exterior surface of the sidewalls of the bin by a mechanical fastener (i.e., screws, bolts, rivets or adhesives).

### BRIEF DESCRIPTION OF THE DRAWINGS

The above and other objects, features and advantages of the present invention will become more apparent from the following detailed description when taken in conjunction with the accompanying drawings in which:

FIG. 1 is perspective view of an a security bin, in accordance with a representative embodiment of the present invention;

FIG. 2 is a top perspective view of a security bin, in accordance with a representative embodiment of the present invention.

FIG. 3 is a side elevation view of an exemplary arrangement of two stacked security bins, in accordance with a representative embodiment of the present invention.

FIG. 4 is a top plan view of a security bin, in accordance with a representative embodiment of the present invention.

FIG. 5A is a detail view of an interior of a handle of a security bin, in accordance with a representative embodiment of the present invention.

FIG. 5B is a detail view of a grip portion of a handle, in accordance with a representative embodiment of the present invention.

FIG. 6A is a detail view of a handle of a security bin, in accordance with a representative embodiment of the present invention.

FIG. 6B is an alternate view of the security bin shown in FIG. 6A, in accordance with a representative embodiment of the present invention.

### DETAILED DESCRIPTION OF THE INVENTION

Exemplary embodiments of the present invention will be described herein below with reference to the accompanying drawings to assist in a comprehensive understanding of exemplary embodiments of the invention as defined by the claims and their equivalents. In the following description, well-known functions or constructions are not described in detail since they would obscure the understanding of the subject matter of the present invention in unnecessary detail by a person of ordinary skill in the art with unnecessary detail of the well-known functions and structures.

Also, the terms used herein are defined according to the functions of the present invention. Thus, the terms may vary depending on user's or operator's intentions or practices. Therefore, the terms used herein must be understood based on the descriptions made herein.

Therefore, the terms used herein should be understood based on the descriptions made herein in view of the ordinary level of skill in the art. The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

In one aspect of the present invention, a security bin is provided having a body comprising a bottom surface in a first plane and four sidewalls extending upwardly from the bottom surface and in a second plane that is perpendicular to the first plane, said bottom surface and sidewalls defining a cargo compartment for receiving personal items. Said body further comprises an opening positioned opposite the bottom surface, and defined by an edge that extends about an upper perimeter of the four sidewalls. The body further comprises at least one handle that is positioned external to the opening and in a plane that is parallel to the bottom surface, wherein the handle extends outwardly from the body in a cantilevered fashion. In some instances, the at least one handle comprises two handles positioned on opposite sides of the body. In some instances, the handle comprises a base that is coupled to the edge. In some instances, the handle comprises a base that is coupled to an outer surface of one or more of the sidewalls. In some instances, the handle comprises a base having a first portion that is coupled to the edge and a second portion that is coupled an outer surface of a sidewall. In some instances, the handle further comprises a grip portion that is separated from the edge and/or sidewall surface by a gap configured to accommodate a user's fingers while gripping the grip portion.

In one aspect, the handle comprises one or more compartments configured to receive a bin identification number that is detectable by X-ray. In some instances, the one or more compartments are hidden within an interior surface or structure of the handle. In some instances, a grip portion of the handle is removable, wherein the one or more compartments are accessible when the grip portion of the handle is removed. In some instances, the handle comprises three compartments. In some instances, the handle further comprises one or more receptacles for selectively receiving and retaining the grip portion onto the base of the handle. In some instances, the handle comprises five compartments in a linear arrangement, wherein the three inner compartments are configured to receive three individual alphanumeric bin identification characters, and the two outer compartments are configured to receive attachment clips of the grip portion to retain the grip portion onto the base of the handle. In some instances, the plurality of compartments further provides structural rigidity to the handle and/or grip portion of the handle.

In another aspect, the present invention provides a security bin having one or more cantilevered handles positioned external to an opening of the bin and positioned in a plane perpendicular to the sidewalls of the bin, wherein the cantilevered handles extend an overall length of the bin to provide and maintain a desired spacing between adjacent bins while being processed through an X-ray scanning machine. In some instances, the cantilevered handles further comprise a bin identification number or other alphanumeric identifying information that is located external to the opening of the bin, and external to one or more sidewall planes of the bin.

In another aspect, the present invention provides a security bin having one or more cantilevered ergonomic handles positioned external to an opening of the bin and positioned in a plane perpendicular to the sidewalls of the bin, wherein the cantilevered ergonomic handle provides a prominent gripping surface that improves a user's ability to grip and hold the security bin, and reduces wrist strain that may occur when attempting to lift a security bin by grasping a narrow lip edge surface with the user's fingertips.

In another aspect, a security bin is provided which allows the user and other observers to immediately identify the security bin by means of visually observing an identification number on one or more surfaces of the bin, wherein the identification number is observable as it enters and exits the X-ray machine, thus minimizing loss or theft of personal belongings, as well as improving the speed, efficiency and confidence in the security process. The identification number is also observable by the X-ray machine operator while the security bin is located within the X-ray scanning machine, thereby enabling the X-ray operator to communicate the identity of the plastic bin to a co-worker by sole reference to the identification number. In turn, the co-worker (i.e., another TSA officer) is able to identify the owner of the contents of the security bin by mere reference to the identification number in questioning the patrons.

Another aspect of the invention provides a security bin having an identification number that is visible both optically and radiopaque, wherein the identification number is detectable by X-rays. In some instances, the security bin comprises two or more identical identification numbers, wherein the first identification number is positioned so as to only optically visible, and the second identification number is positioned so as to be visible to an X-ray operator as the bin passes through an X-ray scanning machine. In some instances, the identification number detectable by X-ray is not optically visible.

Another aspect of the invention provides a method for tracking a plastic bin through an X-ray scanning machine, wherein the method provides steps for i) providing a security bin having at least one identification number coupled to or comprising at least one surface of the security bin, wherein the identification number comprises a radiopaque material and is positioned so as to be optically visible and visible to an X-ray operator as the security bin passes through an X-ray scanning device; ii) noting the identification number prior to passing the security bin through an X-ray scanning machine; iii) recognizing the identification number of the security bin while the bin is located within the X-ray scanning machine; and iv) directing an individual to select the security bin by communicating the recognized identification number to person once the bin has exited the X-ray scanning machine.

A further aspect of the present invention provides a method of manufacturing a security screening bin, comprising steps for: manufacturing a bin by plastic injection molding including molding a cantilevered handle extending from at least one of the edge and a sidewall, such that the handles are positioned outside of, or external to the opening of the bin and a plane of the sidewall.

According to another aspect of the present invention, a method of performing X-ray security screening using a security bin according to the present invention includes: providing a security bin for the use of patrons seeking access to a secured area, and requiring patrons to place personal items in the security bin.

According to another aspect of the present invention, a security bin comprises: an open top, a generally planar floor, a pair of lateral sidewalls and a pair of longitudinal sidewalls, wherein each of said pair of lateral sidewalls and said longitudinal sidewalls are arranged and attached along the perimeter of said generally planar floor in an orthogonal orientation, and wherein each of said lateral sidewalls are attached to each of said longitudinal sidewalls at a substantially right angle, and wherein an edge of said lateral and longitudinal sidewalls positioned opposite of said generally planar floor comprises a lip edge or edge surface of the security bin, wherein the lip edge or edge surface defines an opening of the security, said security bin further comprising a pair of cantilevered handles coupled to at least one of: i) two oppositely positioned sidewalls, and ii) the lip edge or edge surface, wherein grip portions of the pair of cantilevered handles are positioned external to the lip edge or edge surface, the sidewalls, and the generally planar floor.

According to another aspect of the present invention, the bin identification number comprises a radiopaque material selected from the group consisting of a metal plate, a metal sheet, a polymer, an ink, a dye, or any combination thereof, said bin identification number further being embedded in each of the handles.

According to another aspect of the present invention, a security bin further includes a bin number that is optically detectable and affixed to the outside surface of each lateral and each longitudinal sidewall. In some instances, the optically detectable bin number corresponds to the X-ray readable bin number. In some instances, the optically detectable bin number is molded into an exterior surface of the sidewalls of the bin. In some instances, the optically detectable bin number mechanically fixed onto an exterior surface of the sidewalls of the bin by a mechanical fastener (i.e., screws, bolts, rivets or adhesives).

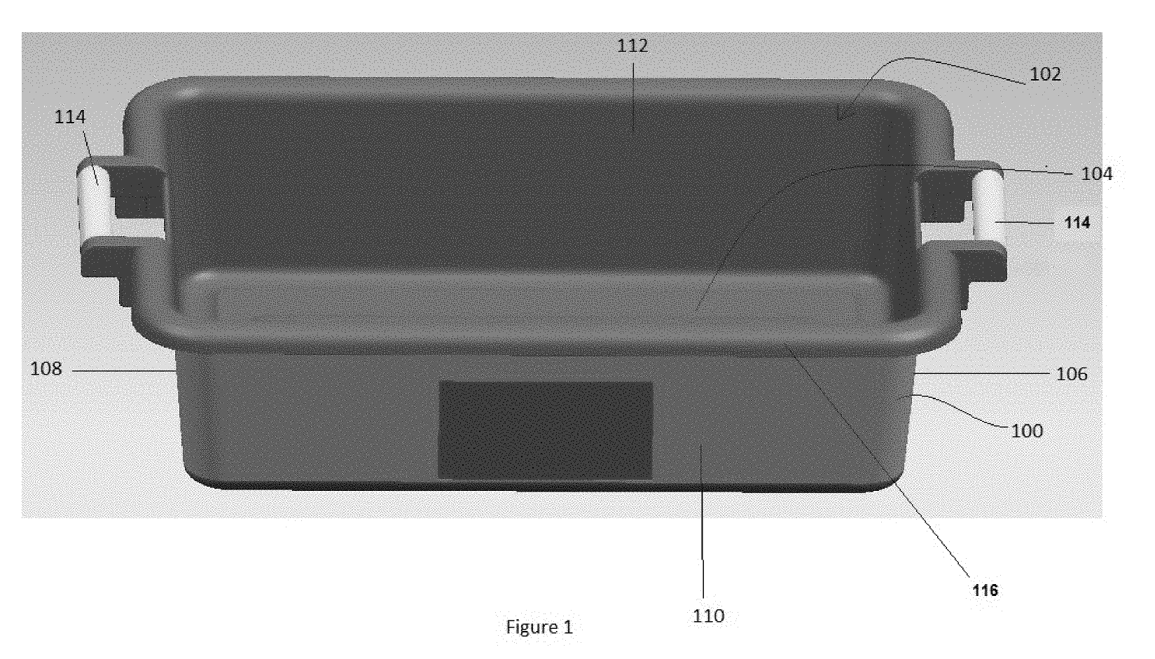

Referring to FIG. 1, an exemplary embodiment of the security bin 100 according to the present invention includes a an open top 102, a generally planar floor 104, pair of lateral sidewalls 106 and 108 and a pair of longitudinal sidewalls 110 and 112 wherein each of said pair of lateral sidewalls and said longitudinal sidewalls are arranged along the perimeter of said generally planar floor 104 and attached to the generally planar floor 104 in an orthogonal orientation and wherein each of said lateral sidewalls 106 and 108 are attached to each of said longitudinal sidewalls 110 and 112 at a substantially right angle at the corner of the perimeter of the generally planar floor. While the security bin 100 according to the present invention is shown and described herein as being generally rectangular in plan view, one skilled in the art will recognize that other shapes are possible within the scope of the present invention, such as for example, square.

The security bin also includes handles 114 attached to the top of each of said lateral sidewalls and extending outwardly there from in a cantilever arrangement. Each handle has embedded therein an X-ray bin identification number not shown in this view which may typically in an exemplary embodiment be three characters which may be letters and numbers. In some instances, only one handle has an X-ray bin identification number. In a typical embodiment, the X-ray visible bin identification number comprises a radiopaque and/or radiolucent material, non-limiting examples of which may include solid metal, metal tape, metal sheet or metal film, dyes, polymers, and combinations thereof, which can be seen when the bin is passed through the X-ray screening machine and which may or may not be optically visible (i.e., visible to the naked eye). In an exemplary embodiment, the metal characters will be encased inside the two handles on each end of the plastic bin and will not be visible to the user of the bins. Each of the handles extend beyond the plan view of the bin floor such that the X-ray visible bin numbers are positioned outside the viewing area of the bin floor such that the X-ray visible bin numbers are not obscured or confused during the X-ray screening process with items contained in the bin, thus hindering identification or intentional attempts by nefarious patrons to interfere with the screening process. While the handles 114 are shown and described in the exemplary embodiment of FIG. 1 as extending outwardly, other configurations are possible within the scope of this invention. For example, the handles 114 may extend inwardly or upwardly at an angle.

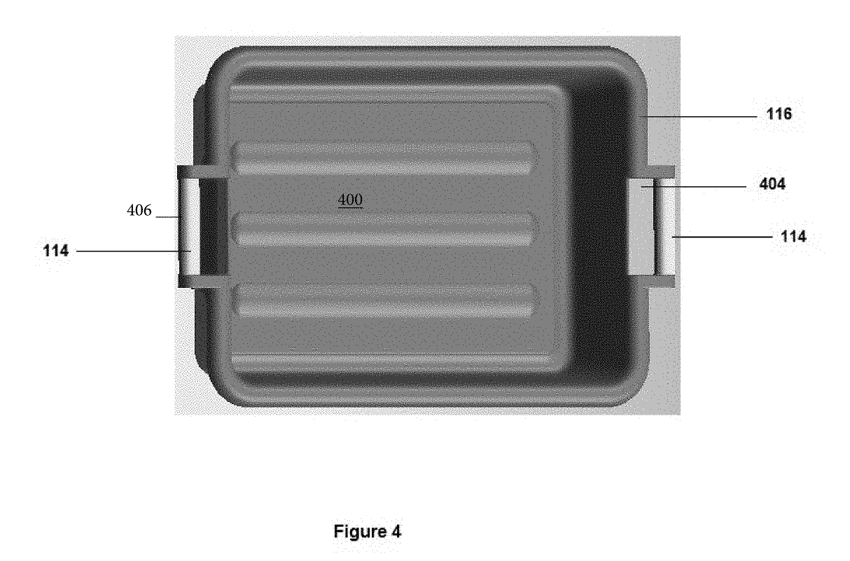

The bin further includes a top lip 116 forming a top for each sidewall to provide lateral support to each wall and thereby enhance strength of the bin walls. Top lip 116 is generally horizontal in orientation; more particularly top lip 116 may be parallel to the generally planar floor 104, although as depicted in FIGS. 1 and 4, top lip 116 has a generally curved shape, and thereby provides an alternate structure for grasping and moving the bin according to the present invention. In such an alternate embodiment, the sidewall area directly under the top lip 116 may have a generally concave recess (not shown) to facilitate a user being able to reach under the top lip 116 and grasp and move the bin. Moreover, as would be obvious to one of skill in the art, while top lip 116 is shown and described as extending outwardly, alternate configurations are possible within the scope of the present invention, such as for example, the top lip 116 may extend inwardly to form an inner rim.

With continued reference to FIG. 1, the bin according to the present invention provides an X-ray visible identification number that may typically be a three character alpha-numeric identification number (or may include less or more than three characters) that is correlated to an externally visible identification number to allow the TSA officer that is operating the X-ray screening machine, to positively identify and select a bin by matching the bin's three character identification number.

In some embodiments, the security bin according to the present invention includes an X-ray visible bin identification number which may be one, two, three, or more three characters in length (typically letters and numbers), made of a radiopaque material, such as solid metal, metal tape or metal film, a polymer, or a dye, and which can be seen when the bin is passed through the X-ray screening machine. In an exemplary embodiment, the radiopaque characters will be encased inside the two handles on each end of the plastic bin and will not be visible to the user of the bins or as described further herein, the X-ray visible identification number may also be embedded in the top lip 116, such that the X-ray visible identification number can only be seen by the TSA officer operating the X-ray screening machine while they are being exposed to the X-rays while inside the screening machine. The security bin according to the present invention provides benefits to the TSA officer operating the X-ray security machine as well as improving the efficiency and the amount of time required for a passenger to go through the TSA security procedure.

The radiopaque characters embedded inside the two handles will match the optically visible bin identification character numbers that will be on the one or more, for example four, outside bin walls. These numbers may be applied to the outside of the plastic bin either by a mechanical attachment such as screws, rivets; decal, paint or pressure/embedding procedure or by apertures formed in the bin walls, shaped to correspond to the bin's identification number, alternately, the optically visible bin identification character numbers may be applied with UV responsive paint or material such that they may be made visible by exposure to UV light. In a further alternate embodiment, the visible bin identification number may be an illuminated LED or LCD panel or pane that is controlled by a remote control that the screening agent switches on or off and in that way the screening procedure can be further enhanced by including a procedure whereby the screening agent may signal when a bin may be retrieved by a patron by illuminating visible bin identification number. The character numbers allow the passenger to visually identify the bin they're using to put their belongings into and to be able to quickly identify said bin after it comes out the X-ray machine and thereby quickly select the correct bin to retrieve their belongings. These character numbers further allow a TSA operator to quickly identify the correct bin to pull off the screening line.

Moreover, the security bin according to some embodiments of the present invention allows for more efficient and effective screening process. In an exemplary method of use, the X-ray screening officer will positively and conclusively identify the bin by using the bin identification number. Therefore, according to the present invention, the method of using the security bin is especially beneficial in high volume screening situations, such as large airports, whereby the X-ray screening officer or operator need only reference the bin identification number observed while the bin was inside the X-ray machine. By searching for the referenced bin identification number, a co-worker (i.e., another TSA officer) can positively identify and remove the correct bin for further inspection. In some instances, the X-ray screening officer directly removes the bin from the belt. In these instances, the bin identification number enables the X-ray screening officer quickly and correctly identify and remove the suspect plastic bin.

In addition, the security bin according to the present invention minimizes patron confusion in retrieving their belongings after screening. Security bins according to the present invention are easily identified by the prominently displayed bin identification number or numbers displayed on one or more of outside bin walls.

In some instances, a passenger is able to identify their bin or bins with greater expediency by merely looking for their specific bin identification number, rather than searching for their belongings, which may appear confusingly similar to belongings of other passengers (e.g., a laptop, computer bag, jacket, etc). Thus, the present invention further provides increased accuracy and efficiency in passenger identification and collection of personal items.

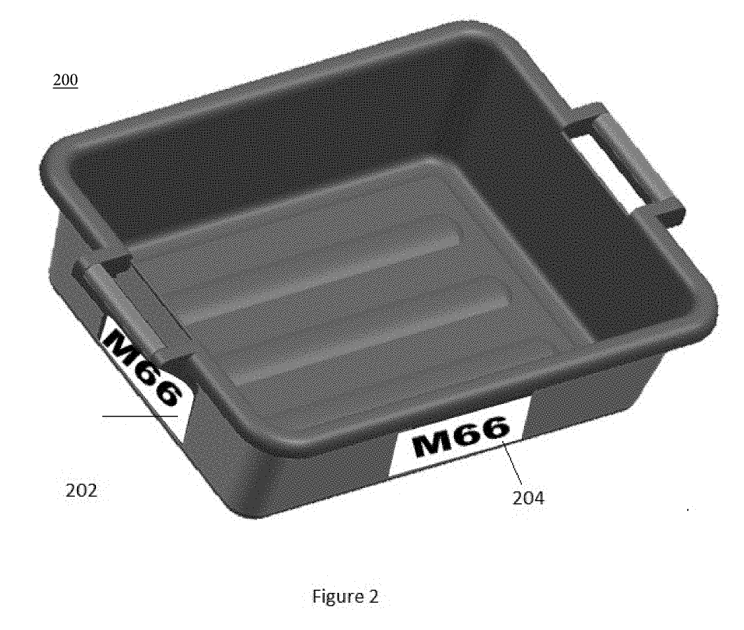

Referring now to FIG. 2, an exemplary embodiment of the security bin 200 according to the present invention which depicts external visible bin identification numbers on the lateral 202 and longitudinal sidewalls 204. In some embodiments, the two additional sidewalls (not visible in this view) also include the bin identification number.

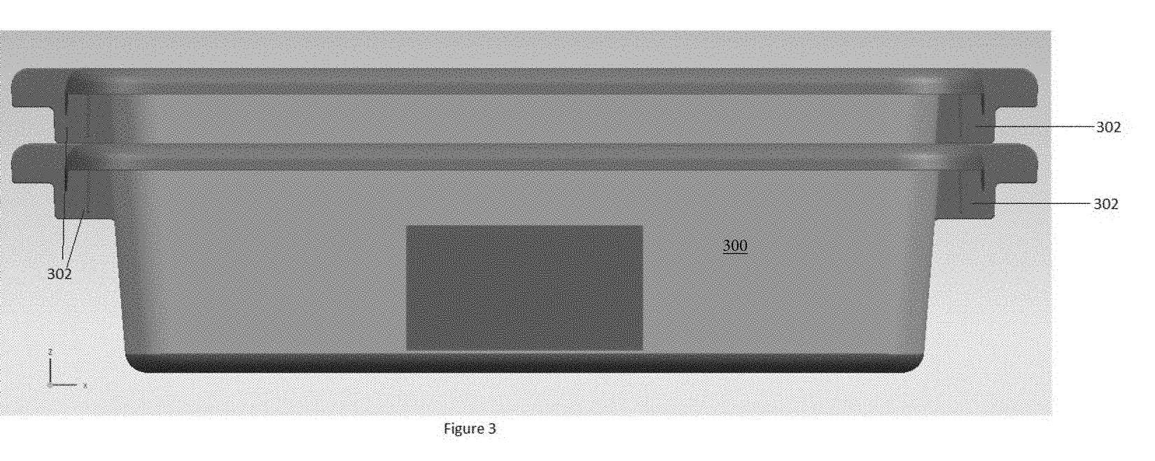

Referring now to FIG. 3, a side elevation view of a representative embodiment of a security bin 300 is shown. In some embodiments, a security bin 300 includes one or more handle support structures 302 for providing a stop or support configured to limit the insertion depth of a second bin within a first bin. As such, multiple bins may be easily and efficiently nested within each other in a stable arrangement for storage. In some embodiments, support structure 302 further prevents over insertion of the second bin, wherein over insertion may require excessive force to remove the second bin from the first bin, which is undesirable.

Referring now to FIG. 4, a further representative embodiment of a security bin 400 is shown. In some embodiments, a security bin 400 includes top lip 116. In some instances, top lip 116 is configured to surround a top edge portion the lateral and longitudinal sidewalls, wherein top lip 116 defines a top opening of bin 400. In some embodiments, bin 400 further comprises one or more handles 114 that are coupled to top lip 116, wherein a grip portion 406 of the handle 114 is separated from top lip 116 and the sidewalls by a gap 404. In some embodiments, the grip portion 406 comprises a gripping material configured to increase friction between handle 114 and the user's hand, thereby assisting the user in gripping handle 114. While the handles are shown and described as having particular orientation, shape and dimension, other configurations, orientations and dimensions are contemplated under the present invention, as would be clear to on skilled in the art.

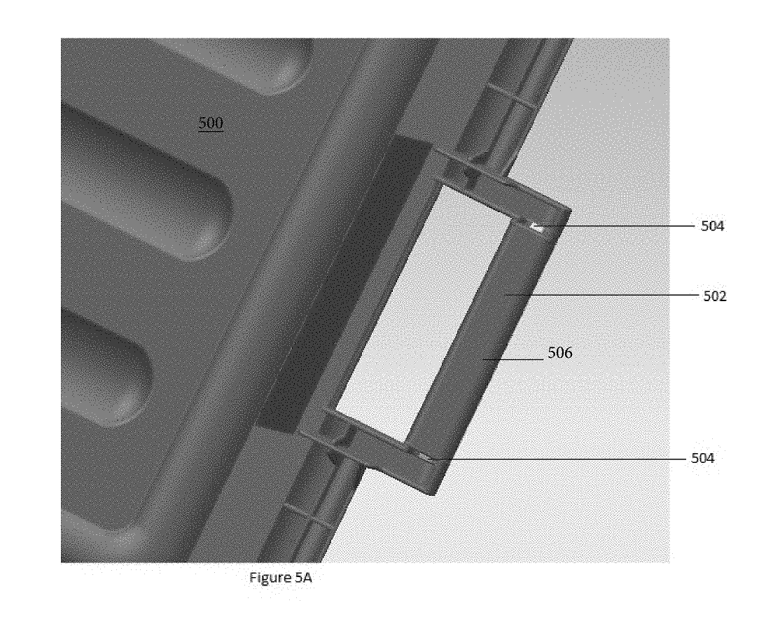

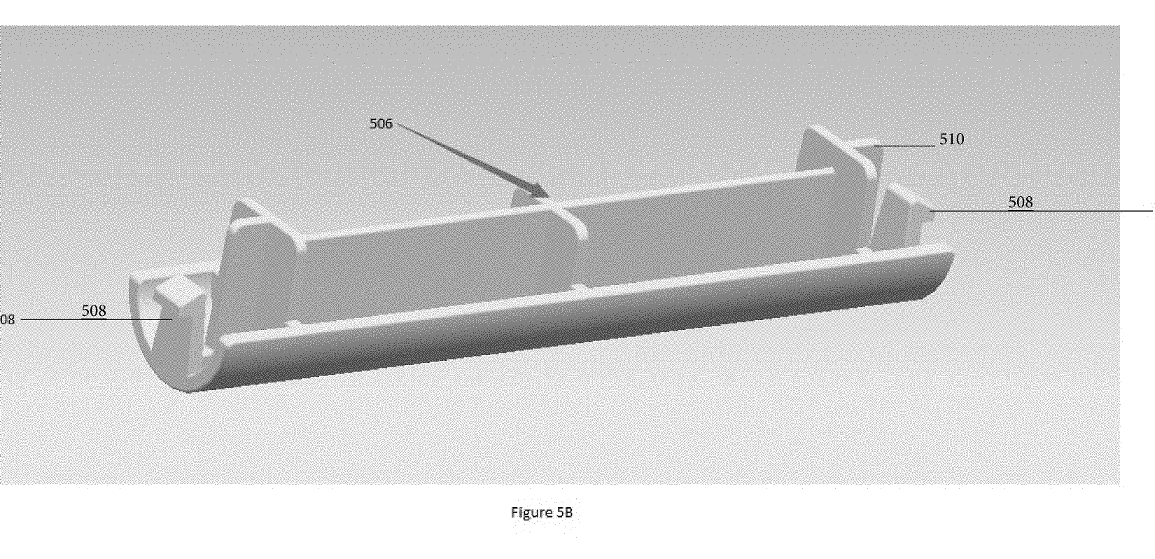

Referring now to FIG. 5A, a detailed view of handle 114 is shown, wherein the grip portion has been removed. In some embodiments, handle 114 comprises a flat surface 502 that is not viewable when the grip portion is attached. In some embodiments, flat surface 502 comprises an x-ray visible identifier that corresponds to a visible bin identification number located on another surface of bin 500. Bin 500 may further comprise one or more slots or compartments 504 for receiving and retaining handle grip tabs (not shown), for example a tag comprising the bin identification number. In some instances, flat surface 502 comprises a plurality of compartments 506, wherein at least some of the compartments are configured to receive the bin identification number. In some instances, handle 114 comprises two compartments 504 for receiving and retaining the grip portion of the handle, and further comprises three or more additional compartments 506 for receiving and storing the bin identification number.

Referring now to FIG. 5B, a detailed view of a grip portion 506 is shown. In some embodiments, grip portion 506 comprises one or more retaining tabs 508 which are configured to insert within, or be received within slots 504 of handle 114, to retain grip portion 506 on flat surface 502. As would be apparent to one skilled in the art, other grips and handle structures may be implemented according to the present invention. The embodiment shown and described is merely exemplary and not limiting. For example, in one embodiment, grip portion 506 is integrally formed with handle 114, wherein the grip portion, the handle, and the bin are formed of the same material during the injection molding process of the bin. Similarly, grips may be attached to the bin sidewall or top lip using mechanical fasteners or adhesive, as is known in the art. In some instances, a raised center structure 510 is configured to compatibly insert within compartments 506, thereby maintaining a desired position of the bin identification number within the interior surface of the handle.

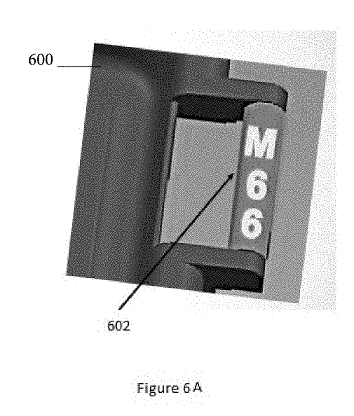

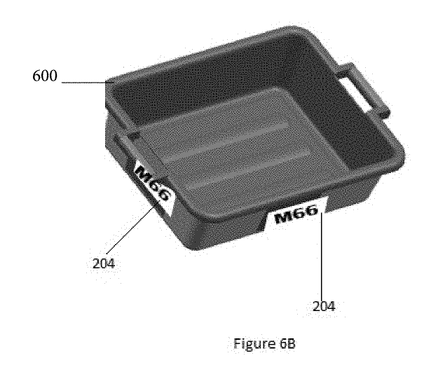

Referring now to FIG. 6A, a representative view of the radiopaque bin identification number located on handle 114, is shown. In some embodiments, the radiopaque bin identification number is viewable only by the X-ray screening officer on the display of the X-ray scanning machine or device. In some embodiments, the radiopaque bin identification number is viewable by X-ray and optically detectable. In some embodiments, the radiopaque bin identification number is located on a surface of the bin, the handle, and/or the grip portion of the handle that is viewable by the X-ray screening officer while the security bin is being scanned by the X-ray scanning machine or device. Accordingly, the location of the radiopaque bin identification number may comprise any X-ray viewable surface of the security bin. In one embodiment, the radiopaque material is selected from the group consisting of solid metal, metal tap, metal sheets, or metal film.

Referring now to FIG. 6B, a perspective view of a representative embodiment of a security bin 600 is shown. In some embodiments, bin 600 further comprises bin identification numbers 204 which are positioned for optical detection. Accordingly, bin identification numbers 204 generally comprise a material that is optically detectable. In some embodiments, bin identification number 204 directly corresponds to a radiopaque bin identification number. In some instances, the bin identification number 204 and the radiopaque bin identification number of bin 600 are the same (meaning, they comprise the same location, material, placement, etc.).

In some embodiments, the bin identification number 204 is positioned at a first location on bin 600, and a radiopaque bin identification number is positioned a second location on bin 600. In some instances, the first and second locations are identical. In some instances, the first and second locations are overlapping. In some instances, the first and second locations do not overlap. In some instances, the first location comprises two or more surfaces of bin 600. In some instances, the second location comprises two or more surfaces of bin 600. In some instances, the first and second locations are in an identical plane. In some instances, the first location is in a first plane and the second location is in a second plane, wherein the first and second planes are parallel. In some instances, the first and second planes are identical. In some instances, the first and second planes are perpendicular. Accordingly, various embodiments of the present invention provide bin identification numbers that are visible by passengers, TSA or screening officers, and X-ray screening operators or officers throughout the entire X-ray screening process.

While the invention has been shown, and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A security bin, comprising:
a body having a bottom surface in a first plane, and four side walls coupled to a perimeter of the bottom surface and extending upwardly from the bottom surface in a second plane that is perpendicular to the first plane, adjacent edges of the four side walls being coupled together to form a continuous sidewall surface, wherein a top edge of each sidewall forms a continuous perimeter edge defining an opening of the body, said sidewalls, bottom surface, and opening defining a cargo compartment of the body;
a handle having a base coupled to the body and extending outwardly therefrom in third plane that is parallel to the first plane, said handle comprising a grip surface coupled to the base and positioned external to the sidewalls, the bottom surface, and the opening; and
a bin identification number coupled to the handle, wherein the bin identification number is detectable by X-ray.

2. The security bin of claim 1, wherein the bin identification number is located in the grip surface.

3. The security bin of claim 1, wherein the bin identification number is located in proximity to the grip surface.

4. The security bin of claim 1, wherein the grip surface is removably coupled to the base.

5. The security bin of claim 1, further comprising a compartment located within an interior surface of the handle, wherein at least a portion of the compartment is configured to receive the bin identification number.

6. The security bin of claim 5, wherein the compartment comprises a plurality of compartments.

7. The security bin of claim 6, wherein the grip surface is removably coupled to the base via one or more retaining tabs configured to selectively couple with one or more of the plurality of compartments.

8. The security bin of claim 1, wherein the bin identification number is positioned within an interior of the handle.

9. The security bin of claim 1, wherein the handle comprises two handles located on opposite sides of the body.

10. The security bin of claim 1, wherein the bin identification number comprising a radiopaque material.

11. The security bin of claim 10, wherein the radiopaque material is selected from the group consisting of a metal, a solid metal, a metal tape, a metal sheet, a metal film, a metal plate, a polymer, an ink, and a dye.

12. The security bin of claim 10, wherein the radiopaque material is a metal plate or a metal sheet.

13. The security bin of claim 1, wherein the handle is an ergonomic handle.

14. The security bin of claim 1, further comprising a gap interposed between the grip surface and the body.

15. The security bin of claim 1, wherein the bin identification number comprises alphanumeric characters.

16. The security bin of claim 15, wherein the bin identification number comprises three alphanumeric characters.

17. The security bin of claim 1, further comprising an optically visible bin identification number.

18. The security bin of claim 1, wherein the bin identification number is embedded into the handle.

19. The security bin of claim 1, wherein the bin identification number is coupled to the handle via a mechanical fastener.

20. The security bin of claim 1, wherein the handle is coupled to at least one of: i) one of the four sidewalls; and ii) the perimeter edge.
